(19) United States
(12) Patent Application Publication
(10) Pub. No.: US 2009/0255913 A1
(43) Pub. Date: Oct. 15, 2009

(54) Rotatable Welding Frame Assembly and Method For Welding a Number of Workpiece Components Into a Single Workpiece

(75) Inventors: Randall K. West, Ortonville, MI (US); Patrick D. Herta, Ortonville, MI (US)

Correspondence Address: REISING ETHINGTON P.C., P O BOX 4390, TROY, MI, 48099-4390, US

(73) Assignee: W Industries, Detroit, MI (US)

(21) Appl. No.: 12/099,931

(22) Filed: Apr. 9, 2008

(51) Int. Cl. H05B 1/00

(52) U.S. Cl. 219/162; 269/40

(57) ABSTRACT

A rotatable welding frame assembly for aligning and welding a number of workpiece components into a single workpiece may include a first frame for supporting one of the workpiece components. The assembly may further include a second frame for supporting another workpiece component. The assembly may further include a pivot interconnecting the first and second frames whereby the second frame can pivot between an open position in which one of the workpiece components can be loaded onto the first frame and another workpiece component can be loaded onto the second frame, and a closed position in which the components are aligned in a predetermined configuration to be welded. The assembly may further include an attachment mechanism associated with the second frame to secure the workpiece component as the second frame pivots from the open to the closed positions.

### FIELD OF THE INVENTION

This invention relates generally to welding fixtures, and more particularly to a rotatable welding frame assembly configured to align a number of workpiece components in a predetermined configuration for welding the components into a single workpiece.

### BACKGROUND OF THE INVENTION

Welding manufacturers use stationary welding fixtures to hold workpiece components in a predetermined configuration. These welding fixtures may remain in one fixed position such that an operator has to make welds in flat, vertical, horizontal and overhead positions. This process can be somewhat cumbersome to the operator, it can increase the weld cycle time and decrease the production rate of the workpieces. Further, the welding fixture may be configured to support only discrete portions of the workpiece along its length, which may allow the components to move relative to each other and increase the manufacturing tolerances.

Accordingly, the inventors have recognized a need for a rotatable welding frame assembly that reduces the manufacturing tolerances and increases welding speed.

### SUMMARY OF THE INVENTION

According to one aspect of the invention, a rotatable welding frame assembly for aligning and welding a number of workpiece components into a single workpiece includes a first frame for supporting one of the workpiece components and a second frame for supporting another workpiece component. The assembly further includes a pivot interconnecting the first and second frames whereby the second frame can pivot between an open position in which one of the workpiece components can be loaded onto the first frame and another workpiece component can be loaded onto the second frame, and a closed position in which the components are aligned in a predetermined configuration to be welded. The assembly further includes an attachment mechanism associated with the second frame to secure the workpiece component as the second frame pivots from the open to the closed positions. In one implementation, the assembly precisely aligns two or more components in the predetermined configuration to reduce the manufacturing tolerances of the workpiece.

According to another aspect of the invention, a method for operating a rotatable welding frame assembly having at least first and second frames for welding a number of workpiece components into a single workpiece includes loading one of the workpiece components onto a workpiece surface of the first frame and loading another workpiece component on a workpiece surface of the second frame member. The method further includes securing the workpiece component in a predetermined position on the second frame. The method further includes moving the second frame to a closed position with respect to the first frame for engaging and holding the workpiece components in a predetermined configuration with respect to each other. The method further includes welding a first joint. The method further includes rotating the first and second frames and the workpiece components therein to another rotational position and welding a second joint. In one implementation, this method precisely aligns two or more components in a predetermined way for making welds in a horizontal position to increase welding speed and penetration.

According to another aspect of the invention, a rotatable welding frame assembly for aligning and welding a number of workpiece components into a single workpiece includes a plurality of frames spaced along a rotational axis. The assembly further includes a plurality of elongated reinforcers interconnecting the plurality of frames. Each elongated reinforcer has a workpiece surface configured to engage and support the workpiece components in a predetermined configuration. In one implementation, this assembly has a significant amount of surface area for holding the components in the predetermined configuration and reducing manufacturing tolerances of the workpiece.

According to another aspect of the invention, a rotatable welding frame assembly for aligning and welding a number of workpiece components into a single workpiece includes a plurality of frames spaced along a rotational axis. Each frame has a workpiece surface configured to engage and hold the workpiece components together in a predetermined way. The frames include a pair of opposing end frames and an intermediate frame disposed therebetween. The assembly further includes a first plurality of locating reinforcers each having one end portion coupled to one end frame and another end portion coupled to the intermediate frame for locating the end frame and the intermediate frame in predetermined positions relative to each other. The assembly further includes a second plurality of locating reinforcers each having one end portion coupled to the other end frame and another end portion coupled to the intermediate frame for locating the end frame and the intermediate frame in predetermined positions relative to each other. The assembly further includes a plurality of elongated reinforcers each having one end portion connected to one end frame, an intermediate portion extending through the intermediate frame and another end portion connected to the other end frame for reinforcing the assembly against twisting. In one implementation, this assembly rotates the workpiece for welding all joints in a horizontal position to increase welding speed, and reduces movement of the components relative to each other to decrease the manufacturing tolerances of the workpiece.

According to another aspect of the invention, a rotary welding system includes a base and a plurality of frames supported on the base for rotational movement with respect to the base about a rotational axis. The frames are spaced along the rotational axis. Each frame has a workpiece surface configured to engage and hold the workpiece components together in a predetermined configuration. The plurality of frames are comprised of a pair of opposing end frames and at least one intermediate frame disposed therebetween. The system further includes a first plurality of locating reinforcers each having one end portion coupled to one end frame and another end portion coupled to the intermediate frame for locating the end frame and the intermediate frame in predetermined positions relative to each other. The system further includes a second plurality of locating reinforcers each having one end portion coupled to the other end frame and another end portion coupled to the intermediate frame for locating the end frame and the intermediate frame in predetermined positions relative to each other. The system further includes a plurality of elongated reinforcers each having one end portion connected to one end frame, an intermediate portion extending through the intermediate frame and another end portion connected to the other end frame for reinforcing the assembly against twisting. The system further includes a drive mechanism engaging at least one of the intermediate frame and the opposing end frames to rotate the assembly and workpiece therein about the rotational axis. The system further includes a controller operably associated with the drive mechanism. The controller is configured to generate a plurality of actuation signals to induce the drive mechanism to rotate the welding frame assembly to a plurality of rotational positions. In one implementation, this system rotates the workpiece to weld each joint while in a predetermined position, and reduces movement of the components relative to each other to decrease the manufacturing tolerances of the workpiece.

According to another aspect of the invention, a method for operating a rotatable welding frame assembly includes opening the rotatable welding frame assembly and loading a plurality of workpiece components in the rotatable welding frame assembly. The method further includes closing the rotatable welding frame assembly to support the workpiece components in the predetermined configuration on a plurality of workpiece surfaces of a plurality of elongated reinforcers. Each elongated reinforcer has one end portion connected to one end frame, an intermediate portion extending through an intermediate frame and another end portion connected to another end frame. The method further includes rotating the end frame, the intermediate frame and the other end frame in synchronization with respect to each other to another rotational position and welding a second joint. In one implementation, this method rotates the workpiece for welding all joints in a horizontal position to decrease the weld cycle time, and reduces movement of the components relative to each other to decrease the manufacturing tolerances of the workpiece.

According to another aspect of the invention, a rotatable welding frame assembly for aligning and welding a number of workpiece components into a single workpiece includes a plurality of frames spaced along a rotational axis. Each of the frames has at least two sections pivotally connected together and configured to move between open and closed positions. One of the sections has a workpiece surface disposed in a substantially horizontal position for supporting one of the workpieces when the section is moved to the open position. The assembly further includes a securing mechanism associated with the section to secure the workpiece component as the section pivots from the open to the closed positions. In one implementation, this assembly eliminates the need to hold the components on the frames before associating the securing mechanisms with the frames.

According to another aspect of the invention, a method for operating a rotatable welding frame assembly having a plurality of frames having at least two sections pivotally interconnected, each of the sections having a workpiece surface portion configured to hold a number of workpiece components in a predetermined configuration includes pivoting one section of the frames to an open position to dispose one of the workpiece surface portions in a substantially horizontal position. The method further includes loading one of the workpiece components on the workpiece surface portion, and loading another workpiece component on another workpiece surface portion. The method further includes pivoting the section of the frames to a closed position to align and hold the workpiece components in a predetermined configuration and making a first weld. The method further includes rotating the rotatable welding frame assembly to another rotational position and making a second weld. In one implementation, this method dispenses with the need to hold the components in predetermined positions on the frames before associating the securing mechanisms with the frames.

### BRIEF DESCRIPTION OF THE DRAWINGS

The following detailed description of exemplary embodiments of the invention will best be understood with reference to the accompanying drawings, in which:

FIG. 1 is a perspective view of a rotary welding system having a rotatable welding frame assembly, in accordance with one exemplary embodiment of the invention;

FIG. 2 is an elevated front view of the rotary welding system of FIG. 1, illustrating the rotatable welding frame assembly moved to an open operational position;

FIG. 3 is a front plan view of the rotary welding system of FIG. 1, illustrating the rotatable welding frame assembly moved from an open operational position to a closed operational position for aligning the workpiece components in a predetermined configuration;

FIG. 4 is a perspective view of the rotary welding system of FIG. 1, illustrating one portion of the rotatable welding frame assembly having a pair of retractable hooks for securing a workpiece component to the assembly and eliminating spring-back of the component;

FIG. 5 is a perspective view of the rotary welding system of FIG. 1, illustrating another portion of the rotatable welding frame assembly having another hook member for securing a workpiece component to the assembly and eliminating spring-back of the component;

FIGS. 6-9 are front plan views of the rotary welding system of FIG. 1, illustrating the rotatable welding frame assembly moved to first, second, third and fourth rotational positions with an operator making horizontal welds on the workpiece;

FIG. 10 is a flowchart of a method for operating the rotary welding system of FIGS. 1-9 to weld a number of workpiece components into a single workpiece, in accordance with another exemplary embodiment of the invention;

FIG. 11 is a perspective view of a rotary welding system having a rotatable welding frame assembly, in accordance with another exemplary embodiment of the invention;

FIG. 12 an elevated front view of the rotary welding system of FIG. 11, illustrating the rotatable welding frame assembly moved to an open operational position;

FIG. 13 is a front plan view of the rotary welding system of FIG. 11, illustrating the rotatable welding frame assembly moved from an open operational position to a closed operational position for aligning the workpiece components in a predetermined configuration; and

FIG. 14 is a flowchart of a method for operating the rotary welding system of FIGS. 11-13 to weld a number of workpiece components into a single workpiece, in accordance with another exemplary embodiment of the invention.

### DETAILED DESCRIPTION OF EXEMPLARY EMBODIMENTS

The present application is directed to a rotatable welding frame assembly, a rotary welding system having the assembly and a method for operating the assembly. The assembly is configured to engage and align a number of workpiece components in a predetermined configuration for welding into a single workpiece. The following description of the embodiments is merely exemplary in nature and is in no way intended to limit the invention, its application, or uses.

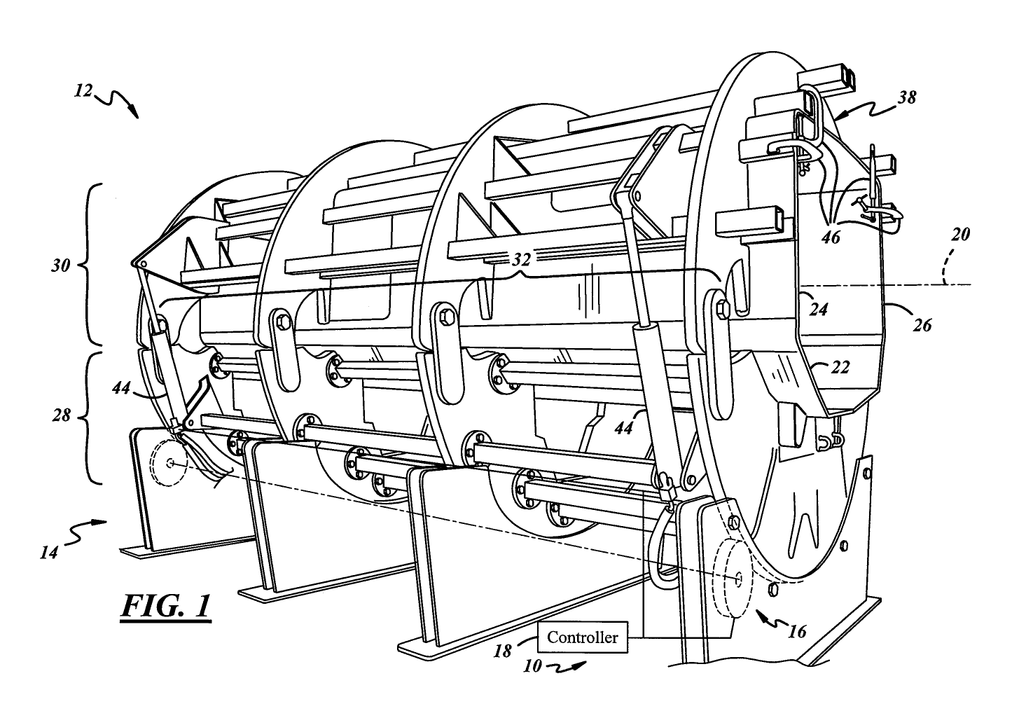

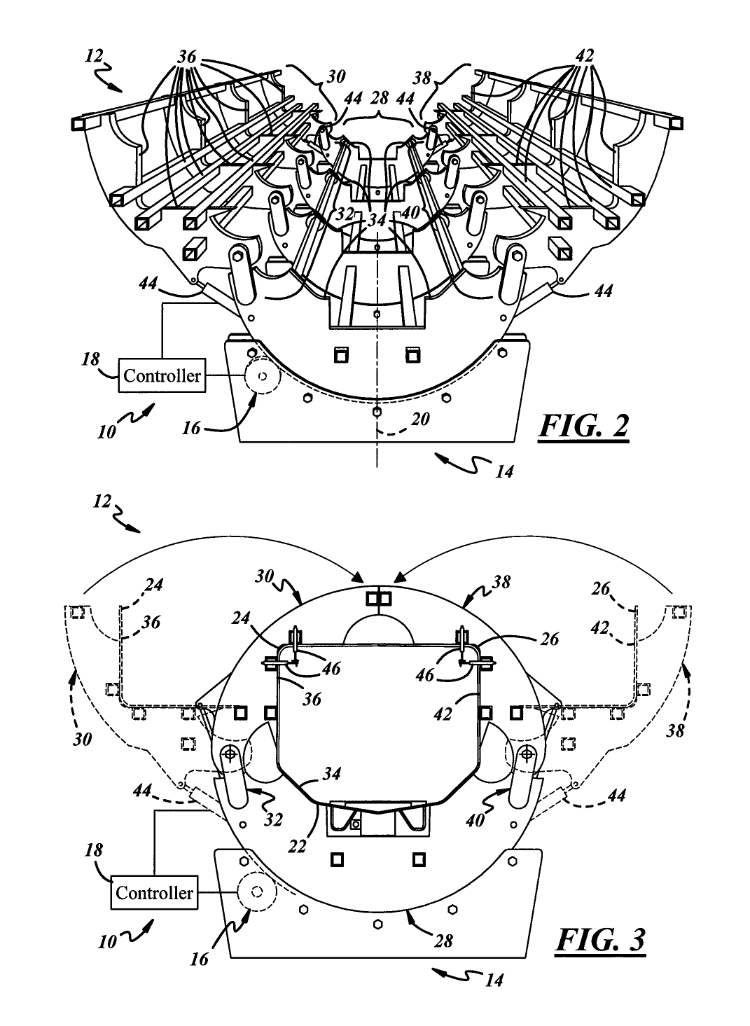

Referring now to FIGS. 1-3, a rotary welding system 10 includes a rotatable welding frame assembly 12 (“assembly”), a base 14, a drive mechanism 16 and a controller 18. As detailed below, the assembly 12 has a rotational axis 20 and is configured to hold a number of workpiece components 22, 24, 26 in a predetermined configuration. The assembly 12 may be configured to align more or less than three components together for welding. The base 14 supports the assembly 12 for rotational movement with respect to the base 14 about the rotational axis 20. The drive mechanism 16 engages the assembly 12 to rotate the assembly 12 and the workpiece components 22, 24, 26 therein about the rotational axis 20. The controller 18 is operably associated with the drive mechanism 16 and configured to generate a plurality of actuation signals to induce the drive mechanism 16 to rotate the assembly 12 and the workpiece components 22, 24, 26 therein to a plurality of rotational positions. Accordingly, each joint between the workpiece components may be welded in a horizontal position to increase welding speed and penetration. However, the joints may instead be welded in flat, vertical, overhead, or horizontal positions or any combination thereof.

The assembly 12 includes a first frame 28, a second frame 30 and a pivot 32. The first and second frames 28, 30 have workpiece surfaces 34, 36, respectively, to support a respective one of the workpiece components 22, 24. The pivot 32 interconnects the first and second frames 28, 30 whereby the second frame 30 can pivot from an open position in which workpiece components 22, 24 can be loaded onto the workpiece surfaces 34, 36, respectively, and a closed position in which the components 22, 24 are aligned in a predetermined configuration and are ready to be welded.

In this embodiment, the assembly 12 further includes a third frame 38 and a pivot 40. The third frame 38 has a workpiece surface 42 to support workpiece component 26. The pivot 40 interconnects the third frame 38 and an end portion of the first frame 28 opposite the second frame 30, whereby the third frame 38 can pivot from an open position in which workpiece component 26 can be loaded onto the workpiece surface 42 and a closed position in which the components 22, 24, 26 are aligned in a predetermined configuration and are ready to be welded. The assembly may include more or less than three frames pivotally connected together.

The assembly 12 further includes one or more hydraulic cylinders 44 associated with the second and third frames 30, 38 to move the second and third frames 30, 38 between the open and closed positions. The hydraulic cylinders 44 may also be configured to hold the second and third frames 30, 38 in the closed position. Instead of the hydraulic cylinders, the assembly 12 may have pneumatic cylinders or various other suitable motors associated with one or more of the frames.

The assembly 12 further includes a plurality of attachment mechanisms associated with the second and third frames 30, 38 to secure the workpiece components 24, 26 as the second and third frames 30, 38 pivot from the open to the closed positions. The attachment mechanisms may be C-clamps 46, other suitable attachment devices or any suitable combination thereof associated with one or more of the frames.

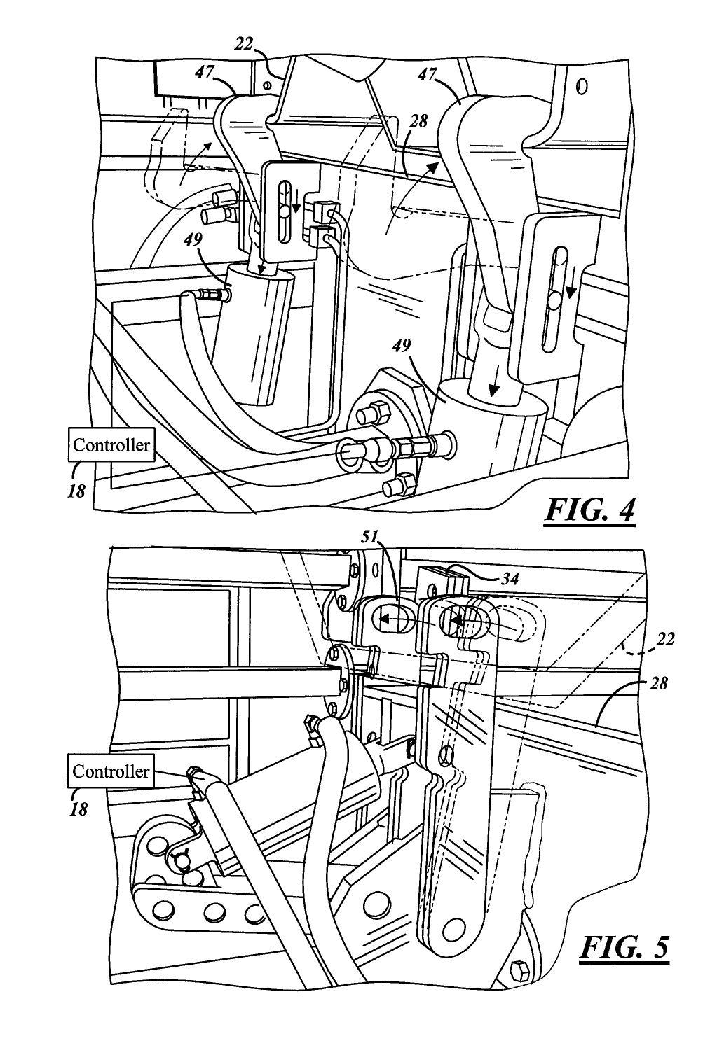

Referring to FIGS. 4 and 5, the attachment mechanisms or securing mechanisms may further include one or more retractable hooks associated with the frames to engage and pull the workpiece components against the workpiece surfaces of the frames. For instance, a pair of retractable hooks 47 may each be associated with a hydraulic cylinder 49 and one portion of the first frame 28 to pull component 22 against surface 34 for eliminating spring-back of component 22 and holding component in a predetermined configuration. Further a retractable hook member 51 may be associated with another hydraulic cylinder 53 and another portion of the first frame 28 to pull component 22 against surface 34.

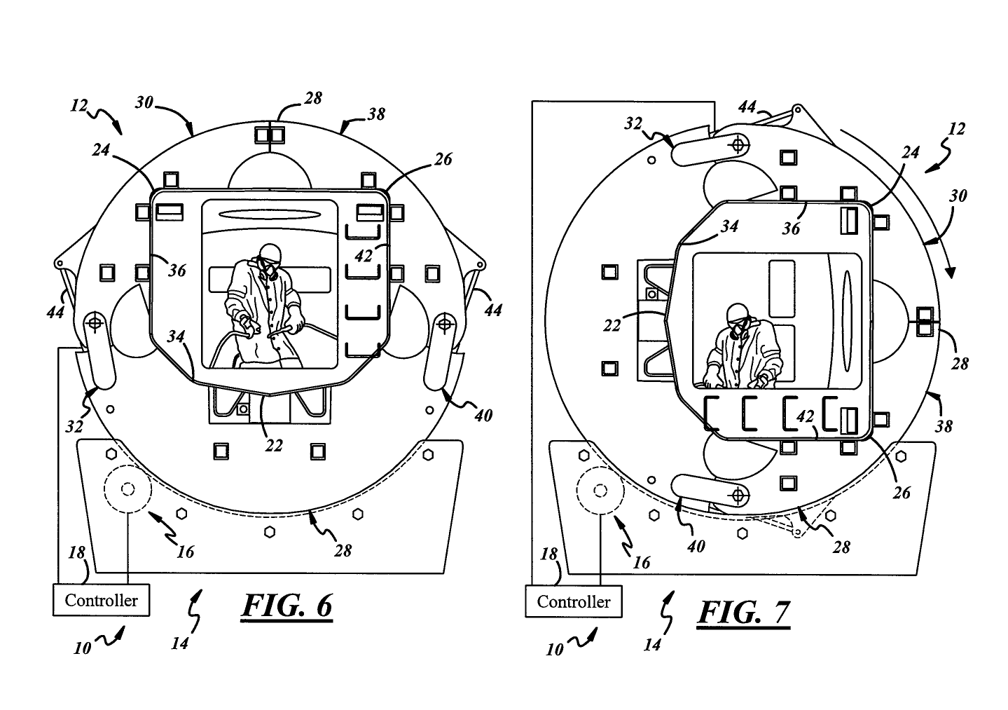

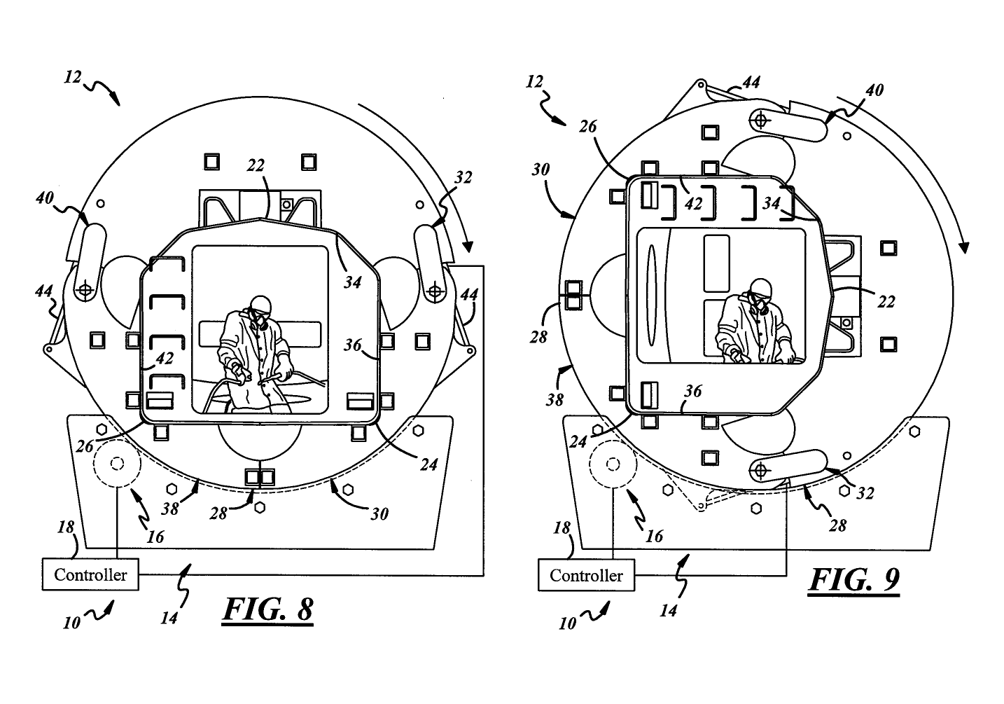

Referring to FIGS. 6-9, the base 14 supports the first, second and third frames 28, 30, 38, respectively, for rotational movement with respect to the base 14 about the rotational axis 20. The drive mechanism 16 engages the first, second or third frames 28, 30, 34 or any combination thereof to rotate the assembly 12 and the workpiece therein about the rotational axis 20. The controller 18 is operably associated with the drive mechanism 16 to generate a plurality of actuation signals to induce the drive mechanism 16 to rotate the assembly 12 to a plurality of rotational positions. This may be accomplished in response to an operator manually actuating the controller or automatically in response to various other conventional methods of actuating the controller. The operator or any suitable welding system known in the art may weld the components in one or more predetermined positions, such as the horizontal position.

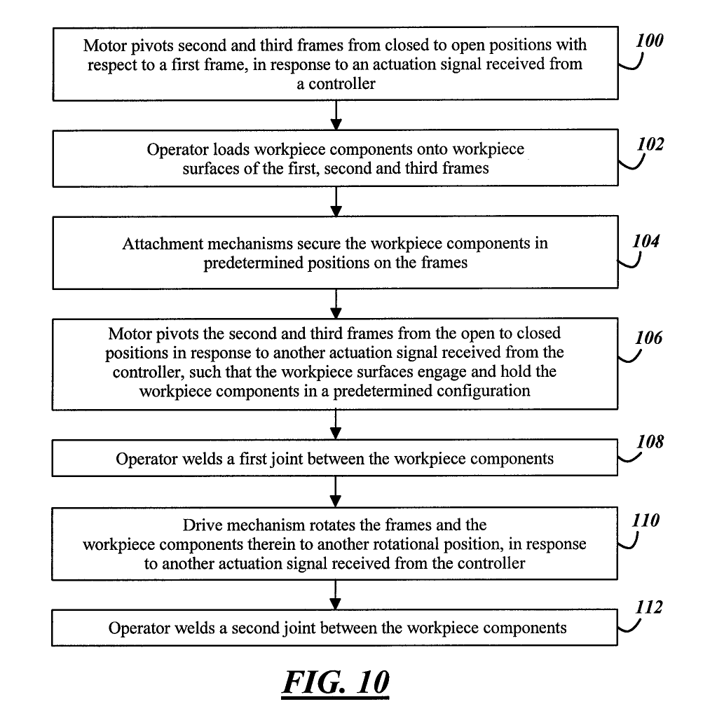

Referring now to FIG. 10, a method for operating the assembly of FIGS. 1-9 will now be explained.

At step 100, the second and third frames 30, 38 are pivoted to the open positions to dispose the workpiece surfaces 34, 42, respectively, in substantially horizontal positions. This step may be accomplished by an operator manually actuating the controller 18 to induce one or more hydraulic cylinders 44 to pivot the second and third frames 30, 38 by ninety degrees from the first frame 28 to the open position. Further, the second and third frames 30, 38 can instead be pivoted to the open positions by more or less than ninety degrees. The assembly 12 may also include more or less than three frames pivotally connected together.

Next at step 102, workpiece components 22, 24, 26 are loaded onto the workpiece surfaces 34, 36, 42, respectively, of the first, second and third frames, 28, 30, 38. This step may be accomplished by an operator operating a crane to load the components onto the workpiece surfaces or manually loading the components onto the surfaces or other suitable loading methods.

Next at step 104, the workpiece components 22, 24, 26 are secured in predetermined positions on the first, second and third frames 28, 30, 38. This step may be accomplished by engaging the plurality of attachment mechanisms with the workpiece components 22, 24, 26 and frames 28, 30, 38, respectively. The attachment mechanisms may include C-clamps 46, retractable hooks 47, 51, hydraulic cylinders, pneumatic cylinders, various other suitable devices or any combination thereof. The C-clamps 46 may secure the workpiece components as the frames 30, 38 move from open to closed positions. The retractable hooks 47, 51 may be associated with the hydraulic cylinders 49, 53 and frames to pull the components radially outward and against the frames for eliminating spring-back of the components. Other hydraulic cylinders may be placed within the workpiece to force the components radially outward from the rotational axis to hold the components against the frames for eliminating spring-back of the components.

Next at step 106, the second and third frames 30, 38 are moved to closed positions with respect to the first frame 28 for engaging and holding the workpiece components 22, 24, 26 in the predetermined configuration. This step may be accomplished by an operator actuating the controller 18 to induce the hydraulic cylinders 44 to move the second and third frames 30, 38 to the closed positions. These hydraulic cylinders 44 may hold the frames 30, 38 in the closed positions.

Next at step 108, an operator welds a first joint between the components. The operator may weld one or more horizontal joints, vertical joints, overhead joints or any combination thereof. In one embodiment, only horizontal welds are made in each rotational position of the assembly 12 to increase welding speed and penetration. This step may be accomplished by an operator using a suitable welding gun or instead by known automated welding mechanisms.

Next at step 110, the first, second and third frames 28, 30, 38 and the workpiece components 22, 24, 26 therein are rotated to another rotational position. This step may be accomplished by the operator actuating the controller 18 to induce the drive mechanism 16 to rotate the first, second and third frames 28, 30, 38 about the rotational axis 20 with respect to the base 14.

Next at step 112, the operator welds a second joint between the components. Similarly, as in step 108, the operator may weld one or more horizontal joints, vertical joints, overhead joints or any combination thereof. In this embodiment, the operator makes only horizontal welds of the workpiece in each rotational position of the assembly 12. This step may be accomplished by an operator using a suitable welding gun or instead by known welding mechanisms known in the art.

Steps 110 and 112 can be repeated to make other welds in various other positions. Upon completing the welds, the controller 18 may generate an actuation signal to induce the hydraulic cylinders 44 to move the second and third frames 30, 38 to the open position, so that the operator may remove the completed single workpiece from the assembly 12.

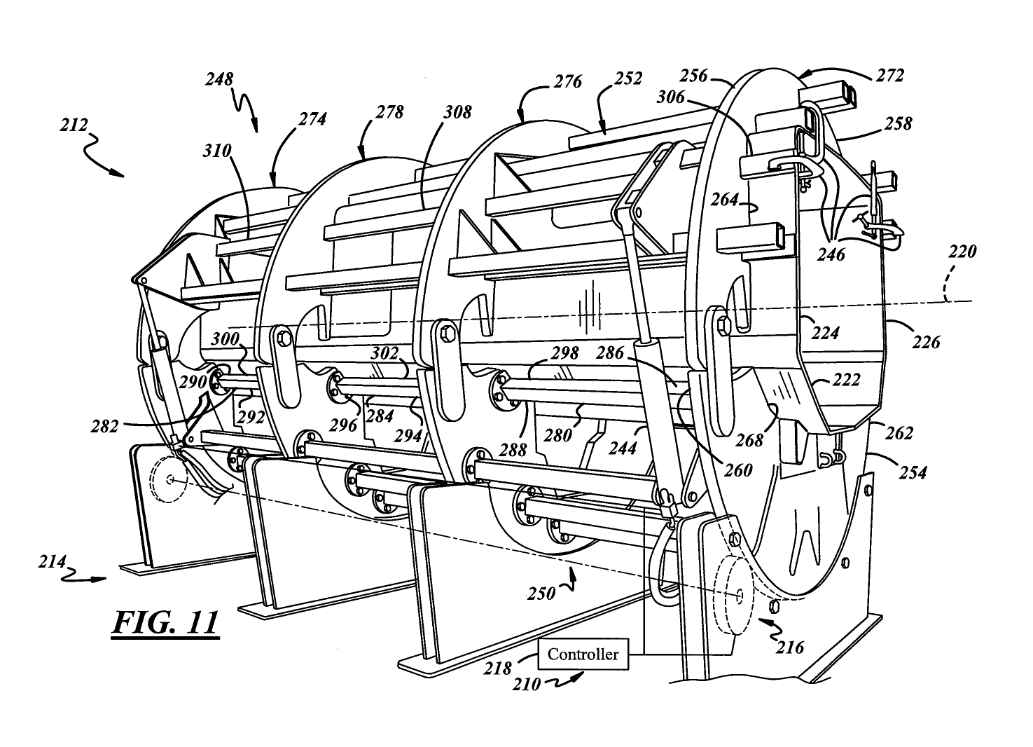

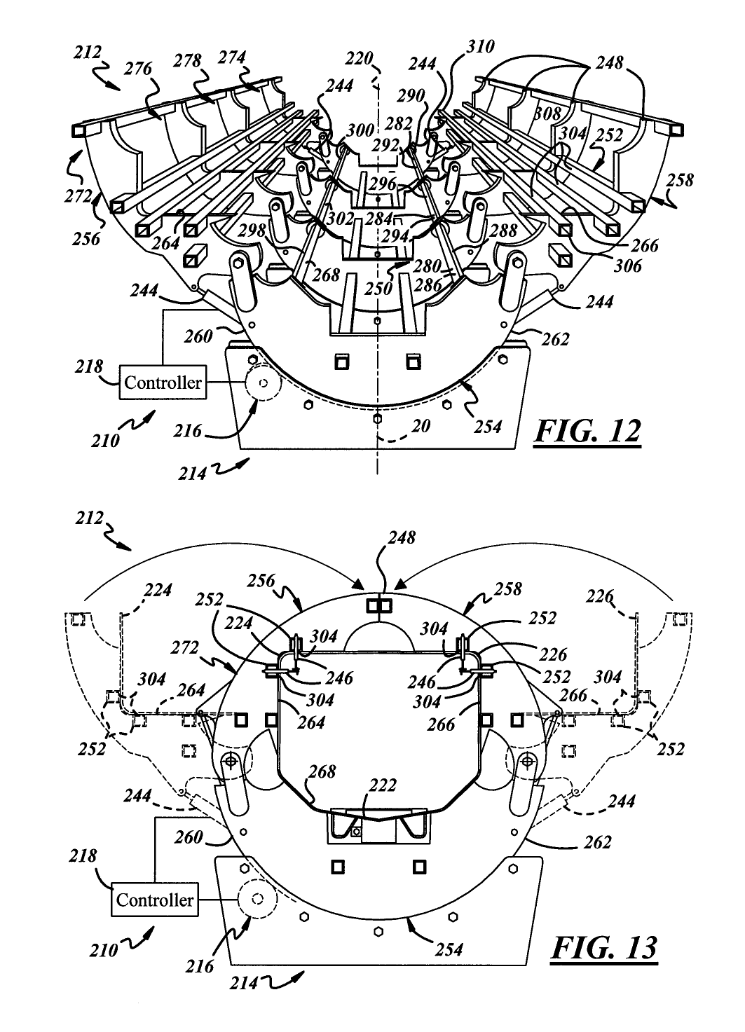

FIGS. 1-9 show the assembly 12 having first, second and third frames 28, 30, 38 pivotally connected together according to one embodiment of the invention. FIGS. 11-13 show the identical structure of FIGS. 1-3, respectively, as one example of an assembly according to another embodiment of the invention. This structure includes a plurality of spaced apart circular frames interconnected by reinforcers rather than the assembly 12 of FIGS. 1-9 having the first, second and third frames 28, 30, 38 pivotally connected together.

Referring now to FIGS. 11-13, a rotary welding system 200 having a rotatable welding frame assembly 212 (“assembly”), a base 214, a drive mechanism 216, and a controller 218, is substantially similar to the rotary welding system 10 of FIGS. 1-9 having the assembly 12, the base 14, the drive mechanism 16, and the controller 18, respectively. However, as detailed below, the assembly 212 has a plurality of circular frames 248 interconnected by a combination of locating reinforcers 250 and elongated reinforcers 252, as compared to the assembly 12 of FIG. 1 having first, second and third frames 28, 30, 38.

The circular frames 248 are spaced along the rotational axis 220. The circular frames 248 include a pair of opposing end frames 272, 274 and two intermediate frames 276, 278 disposed therebetween. However, the circular frames 248 may instead include more or less than two intermediate frames. Each frame 248 has an outer perimeter that is circular in shape or other suitable shapes as desired. Further, each frame 248 has two or more sections 254, 256 pivotally connected together and configured to move between open and closed positions. In this embodiment, each circular frame 248 has three sections 254, 256, 258. Section 256 is pivotally connected to one end portion 260 of section 254, and section 258 is pivotally connected to the other end portion 262 of section 256 opposite section 256.

Sections 256, 258 have workpiece surfaces 264, 266, respectively, disposed in substantially horizontal positions for supporting workpiece components 224, 226 when the sections 256, 258 are moved to the open position. Accordingly, an operator can load the workpiece components 224, 226 onto the surfaces 264, 266, respectively, such that those components remain in predetermined positions on those sections. The workpiece surfaces 264, 266 may be planar, concave or otherwise configured to support and hold the components 224, 226 in the fixed positions when the sections 256, 258 are in the open position.

Section 254 has a workpiece surface 268 configured to receive and support another workpiece component 222 when the sections 256, 258 are moved to the open position.

The workpiece surfaces 264, 266, 268 are configured to engage and hold the workpiece components 222, 224, 226 together in a predetermined configuration when the sections 256, 258 are moved to the closed position.

The assembly 212 further includes one or more hydraulic cylinders 244 or other motors to move the sections 256, 258 between the open and closed positions. The motor 244 may be a hydraulic motor or other suitable motors. Further, the motors 244 may be configured to hold the sections 256, 258 in the closed position.

The assembly 12 further includes a plurality of securing mechanisms 270 associated with the sections 256, 258 to secure the workpiece components 222, 224 to sections 256, 258 or other suitable portions of the assembly as the sections pivot from the open to the closed positions. These securing mechanisms may be C-clamp devices 246 or various other suitable attachment mechanisms as desired. The securing mechanisms may further include one or more retractable hooks associated with hydraulic cylinders and the sections to pull the components against the sections for eliminating spring-back and holding the components in a predetermined way. Other hydraulic cylinders may be disposed within the workpiece to force the components radially outward from the rotational axis toward the workpiece surfaces.

The locating reinforcers 250 may include a first plurality, a second plurality and a third plurality of locating reinforcers 280, 282, 284. The first plurality of locating reinforcers 280 each have one end portion 286 coupled to one end frame 272 and another end portion 288 coupled to one intermediate frame 276 for locating the end frame 272 and the intermediate frame 276 in predetermined positions relative to each other. The second plurality of locating reinforcers 282 each have one end portion 290 coupled to the other end frame 274 and another end portion 292 coupled to the other intermediate frame 278 for locating the end frame 274 and the other intermediate frame 278 in predetermined positions relative to each other. The third plurality of locating reinforcers 284 each have one end portion 294 coupled to one intermediate frame 276 and another end portion 296 coupled to the other intermediate frame 278 for locating the intermediate frames 276, 278 in predetermined positions relative to each other. Accordingly, the assembly 212 can be built within substantially small tolerances to reduce the manufacturing tolerances of the workpiece.

Each locating reinforcer of the first plurality, second plurality and third plurality of locating reinforcers 280, 282, 284 has a workpiece surface 298, 300, 302, respectively, configured to engage and support the workpiece components in the predetermined configuration. For instance, the workpiece surfaces 298, 300, 302 of the locating reinforcers extend from and are coplanar with the workpiece surfaces 298 of the circular frames 28. Accordingly, the assembly 12 provides a substantial amount of surface area for holding the workpiece in the predetermined configuration to reduce the manufacturing tolerances of the workpiece. Nevertheless, one or more of the locating reinforcers may not be configured to engage and support the workpiece components, such as those reinforcers located on outer portions of the frames.

The elongated reinforcers 252 each have a workpiece surface 304 configured to engage and support the workpiece components 222, 224, 226 in the predetermined configuration. For instance, the workpiece surfaces 304 of the elongated reinforcers 252 may extend from and be coplanar with the workpiece surfaces 264, 266 of the frames 250.

The elongated reinforcers 252 each have one end portion 306 connected to one end frame 272, an intermediate portion 308 extending through the intermediate frames 276, 278 and another end portion 310 connected to the other end frame 274 for reinforcing the assembly 12 against twisting. Accordingly, the elongated reinforcers 252 cause synchronous rotation of the frames 272, 274, 276, 278 with respect to each other, such that the workpiece components 222, 224, 226 therein remain precisely in the predetermined configuration as the assembly 212 rotates on the base 214. The assembly 212 may include only locating reinforcers, only elongated reinforcers or any suitable combination thereof.

The assembly 212 further includes one or more hydraulic cylinders 244 to move the sections 256, 258 between the open and closed positions. Nevertheless, the assembly 12 can instead include pneumatic cylinders or other suitable motors. Further, the cylinders 244 may be configured to hold the sections 256, 258 in the closed position.

The drive mechanism 216 engages one end frame 272, the intermediate frames 276, 278, the other end frame 274 or any combination thereof to rotate the assembly 212 and the workpiece therein about the rotational axis 220.

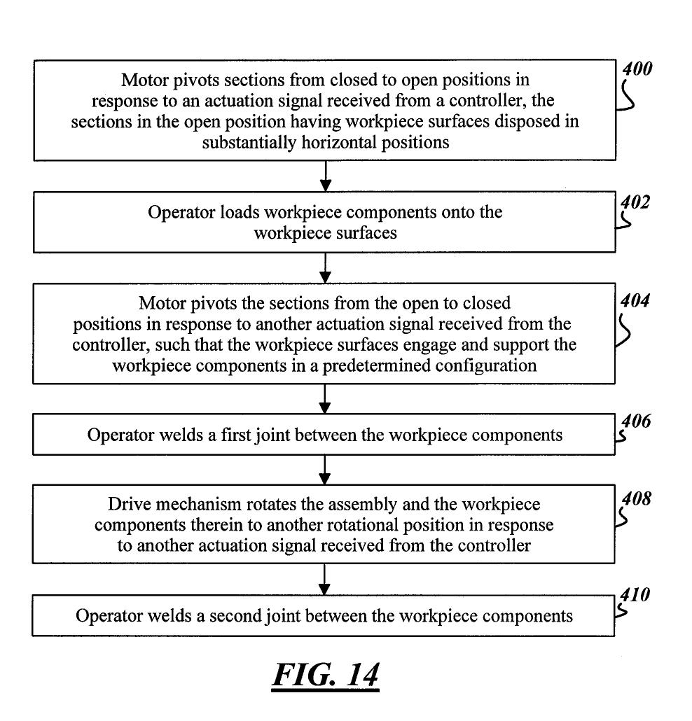

Referring now to FIG. 14, a method for operating the assembly 212 will now be explained, in accordance with one exemplary embodiment of the invention.

At step 400, the sections 256, 258 are pivoted to open positions to dispose the workpiece surfaces 264, 266 in substantially horizontal positions. This step may be accomplished by an operator manually actuating the controller 218 to induce one or more hydraulic cylinders 244 to pivot the sections 256, 258 ninety degrees from section 254 to the open position. Nevertheless, the sections 256, 258 can instead be pivoted by more or less than ninety degrees. Each frame 248 may also include more or less than three sections 254, 256, 258 pivotally connected together.

Next at step 402, the workpiece components 222, 224, 226 are loaded onto one or more workpiece surfaces 264, 266, 268 of sections 254, 256, 258, as well as the workpiece surfaces 304 of the elongated reinforcers 252. Accordingly, a substantial amount of surface area engages and holds the components in the predetermined configuration to reduce the manufacturing tolerances of the workpiece. Depending on the mass of the components, this step may be accomplished by an operator actuating a crane to lift the workpiece components onto the workpiece surfaces or by an operator manually loading the components onto the surfaces.

Next at step 404, the sections 256, 258 are pivoted to the closed position to align and hold the workpiece components 222, 224, 226 in the predetermined configuration. This step may be accomplished by the operator actuating the controller 218 to induce the motors 244 to pivot the sections 256, 258 ninety degrees toward section 254 to the closed position.

Next at step 406, the operator makes a first weld between one or more joints between the workpiece components. However, any suitable welding device known in the art may instead make the first weld.

Next at step 408, the assembly 212 is rotated to another rotational position. This step may be accomplished by an operator actuating the controller 218 to generate the actuation signals to induce the drive mechanism 216 to rotate the assembly 212.

Next at step 410, the operator makes a second weld between one or more joints between the workpiece components. However, similar to step 408, any suitable known welding device may instead make the first weld.

Steps 408 and 410 can be repeated to make other welds in various other positions. Upon completing the welds, the controller 218 may generate an actuation signal to induce the motors 244 to move the second and third sections 256, 258 to the open position, so that the completed single workpiece can be removed from the assembly 212.

The rotatable welding frame assembly, the rotary welding system and methods described herein provide a substantial advantage over other devices and methods. In particular, the rotatable welding frame assembly and the rotary welding system provide a technical effect of reducing manufacturing tolerances and decreasing the weld cycle time.

The above description of embodiments of the invention is merely exemplary in nature and, thus, variations thereof are not to be regarded as a departure from the spirit and scope of the invention.

What is claimed is:

1. A rotatable welding frame assembly for aligning and welding a number of workpiece components into a single workpiece, comprising:
a first frame for supporting one of the workpiece components;
a second frame for supporting another workpiece component;
a pivot interconnecting the first and second frames whereby the second frame can pivot between an open position in which one of the workpiece components can be loaded onto the first frame and another workpiece component can be loaded onto the second frame, and a closed position in which the components are aligned in a predetermined configuration and ready to be welded; and
the assembly further including an attachment mechanism associated with the second frame to secure the workpiece component as the second frame pivots from the open to the closed positions.

2. The assembly of claim 1, further comprising a base supporting the first and second frames for rotational movement with respect to the base about the rotational axis.

3. The assembly of claim 1, further comprising another attachment mechanism associated with the workpiece component and the first frame to secure the workpiece component in a predetermined position on the first frame.

4. A method for operating a rotatable welding frame assembly having at least first and second frames for welding a number of workpiece components into a single workpiece, the method comprising:
loading one of the workpiece components onto a workpiece surface of the first frame;
loading another workpiece component on a workpiece surface of the second frame;
securing the workpiece component in a predetermined position on the second frame;
moving the second frame to a closed position with respect to the first frame for engaging and holding the workpiece components in a predetermined configuration with respect to each other;
welding a first joint;
rotating the first and second frames and the workpiece components therein to another rotational position; and
welding a second joint.

5. The method for claim 4 further comprising engaging an attachment mechanism with the workpiece component and the first frame.

6. The method for claim 4 further comprising securing the workpiece component in a predetermined position on the first frame.

7. The method for claim 6 further comprising engaging another attachment mechanism with the workpiece component and the first frame.

8. A rotatable welding frame assembly for aligning and welding a number of workpiece components into a single workpiece, comprising:
a plurality of circular frames spaced along a rotational axis; and
a plurality of elongated reinforcers interconnecting the plurality of circular frames, each elongated reinforcer having a workpiece surface configured to engage and support the workpiece components in a predetermined configuration.

9. The rotatable welding frame assembly of claim 8, wherein each of the circular frames has a workpiece surface configured to engage and hold the workpiece components in the predetermined configuration

10. The rotatable welding frame assembly of claim 8, further comprising a base supporting the plurality of circular frames for rotational movement with respect to the base about the rotational axis.

11. A rotatable welding frame assembly for aligning and welding a number of workpiece components into a single workpiece, comprising:
a plurality of circular frames spaced along a rotational axis, each of the circular frames having a workpiece surface configured to engage and hold the workpiece components together in a predetermined way, the plurality of circular frames comprised of a pair of opposing end frames and an intermediate frame disposed therebetween;
a first plurality of locating reinforcers each having one end portion coupled to one end frame and another end portion coupled to the intermediate frame for locating the end frame and the intermediate frame in predetermined positions relative to each other;
a second plurality of locating reinforcers each having one end portion coupled to the other end frame and another end portion coupled to the intermediate frame for locating the end frame and the intermediate frame in predetermined positions relative to each other;
a plurality of elongated reinforcers each having one end portion connected to one end frame, an intermediate portion extending through the intermediate frame and another end portion connected to the other end frame for reinforcing the assembly against twisting.

12. The rotatable welding frame assembly of claim 11, wherein each of the first plurality of locating reinforcers has a workpiece surface configured to engage and support the workpiece components in the predetermined way.

13. The rotatable welding frame assembly of claim 11, wherein each of the second plurality of locating reinforcers has a workpiece surface configured to engage and support the workpiece components in the predetermined way.

14. The rotatable welding frame assembly of claim 11, wherein each of the elongated reinforcers has a workpiece surface configured to engage and support the workpiece components in the predetermined way.

15. A rotary welding system, comprising:
a base;
a plurality of circular frames supported on the base for rotational movement with respect to the base about a rotational axis, the plurality of circular frames spaced along the rotational axis, each of the circular frames having a workpiece surface configured to engage and hold the workpiece components together in a predetermined configuration, the plurality of circular frames comprised of a pair of opposing end frames and at least one intermediate frame disposed therebetween;
a first plurality of locating reinforcers each having one end portion coupled to one end frame and another end portion coupled to one of the intermediate frames to locate the end frame and the intermediate frame in predetermined positions relative to each other;
a second plurality of locating reinforcers each having one end portion coupled to the other end frame and another end portion coupled to one of the intermediate frames to locate the end frame and the intermediate frame in predetermined positions relative to each other;
a plurality of elongated reinforcers each having one end portion connected to one end frame, an intermediate portion extending through the intermediate frame and another end portion connected to the other end frame for reinforcing the assembly against twisting;
a drive mechanism engaging at least one of the intermediate frame and the opposing end frames to rotate the welding frame assembly and the workpiece therein about the rotational axis; and
a controller operably associated with the drive mechanism, the controller configured to generate a plurality of actuation signals to induce the drive mechanism to rotate the welding frame assembly to a plurality of rotational positions.

16. The rotary welding system of claim 15, wherein each of the first plurality of locating reinforcers has a workpiece surface configured to engage and support the workpiece components in the predetermined configuration.

17. The rotary welding system of claim 15, wherein each of the second plurality of locating reinforcers has a workpiece surface configured to engage and support the workpiece components in the predetermined configuration.

18. The rotatable welding frame assembly of claim 15, wherein each of the elongated reinforcers has a workpiece surface configured to engage and support the workpiece components.

19. A method for operating a rotatable welding frame assembly comprising:
opening the rotatable welding frame assembly;
loading a plurality of workpiece components in the rotatable welding frame assembly;
closing the rotatable welding frame assembly to support the workpiece components in the predetermined configuration on a plurality of workpiece surfaces of a plurality of elongated reinforcers each having one end portion connected to one end frame, an intermediate portion extending through an intermediate frame and another end portion connected to another end frame;
welding a first joint;
rotating the end frame, the intermediate frame and the other end frame in synchronization with respect to each other to another rotational position; and
welding a second joint.

20. The method for claim 19, further comprising supporting the workpiece components in a predetermined configuration on a plurality of workpiece surfaces of the end frame, the intermediate frame and the other end frame.

21. The method for claim 19, further comprising supporting the workpiece components in a predetermined configuration on a first plurality of locating reinforcers each having one end portion connected to the end frame and another end portion connected to the intermediate frame.

22. The method for claim 21, further comprising supporting the workpiece components in a predetermined configuration on a second plurality of locating reinforcers each having one end portion connected to the intermediate frame and another end portion connected to the other end frame.

23. A rotatable welding frame assembly for aligning and welding a number of workpiece components into a single workpiece, comprising:
a plurality of frames spaced along a rotational axis, each of the frames having at least two sections pivotally connected together and configured to move between open and closed positions, one of the sections having a workpiece surface disposed in a substantially horizontal position for supporting one of the workpieces when the section is moved to the open position; and
a securing mechanism associated with the section to secure the workpiece component as the section pivots from the open to the closed positions.

24. A method for operating a rotatable welding frame assembly having a plurality of frames each having at least two sections pivotally interconnected, the sections having workpiece surfaces to hold a number of workpiece components in a predetermined configuration, the method comprising:
pivoting one section of the frames to an open position to dispose one of the workpiece surface portions in a substantially horizontal position;
loading one of the workpiece components on the workpiece surface portion;
loading another workpiece component on another workpiece surface portion of the frames;
pivoting the section of the frames to a closed position to align and hold the workpiece components in a predetermined configuration;
making a first weld;
rotating the rotatable welding frame assembly to another rotational position; and
making a second weld.
